(19) United States
(12) Patent Application Publication
(10) Pub. No.: US 2025/0217482 A1
(43) Pub. Date: Jul. 3, 2025

(54) MONITORING SERVER APPARATUS, SYSTEM, METHOD, AND PROGRAM

(71) Applicant: NEC Corporation, Minato-ku, Tokyo (JP)

(72) Inventor: Yoshifumi HORIE, Tokyo (JP)

(73) Assignee: NEC Corporation, Minato-ku, Tokyo (JP)

(21) Appl. No.: 18/848,569

(22) PCT Filed: Mar. 24, 2022
(86) PCT No.: PCT/JP2022/013884

§ 371 Date: Sep. 19, 2024

(51) Int. Cl. G06F 21/55

(52) U.S. Cl. CPC G06F 21/554; G06F 2221/034

(57) ABSTRACT

A monitoring server apparatus comprises an operation section configured to collect from monitored apparatuses predetermined logs excluding kernel trace information during operation, monitor an anomaly of the monitored apparatuses using a model created in advance, and perform dynamic monitoring by narrowing its focus to kernel space of a monitored apparatus having the anomaly when any anomaly has occurred.

### TECHNICAL FIELD

The present invention relates to a monitoring server apparatus, system, method, and program.

### BACKGROUND ART

A technology that monitors system anomalies primarily collects (obtains) monitoring information such as sensor information, event information, log information, and trace information. For instance, Patent Literature 1 discloses a method for detecting anomalies of equipment using operating information such as the operating time of the equipment and output signals (sensor information) from a plurality of sensors appended to the equipment. Further, Patent Literature 2 discloses a method for monitoring the state of a system by obtaining trace logs (log information) related to a program's operation. Patent Literature 3 discloses a method for monitoring the state of a system by obtaining information on events that occur during the execution of a debugged program (event information). Furthermore, Patent Literature 4 discloses a method for monitoring the state of a system by collecting trace information from the system's kernel space (kernel trace information).

### CITATION LIST

### Non Patent Literature

### Patent Literature 1:

International Publication Number WO2013/24613

### Patent Literature 2:

Japanese Patent Kokai Publication No. JP-P2009-237610A

### Patent Literature 3:

Japanese Patent Kokai Publication No. JP-P2001-34503A

### Patent Literature 4:

Japanese Patent Kokai Publication No. JP-P2000-76095A

### SUMMARY

### Technical Problem

The following analysis is provided by the inventor of the present invention.

However, the methods that collect (obtain) operating information, sensor information, log information, and event information to monitor the state of a system, as described in Patent Literatures 1 to 3, primarily focus on monitoring system performance, and it is difficult for these methods to dynamically monitor kernel-level issues such as failures near the kernel or hardware, system tampering, and cyberattacks. Further, the method that collects trace information from the kernel space to monitor the state of a system, as described in Patent Literature 4, uses CPU (Central Processing Unit) exception handling, and this results in significant processing overhead, limiting the number of probe points that can be monitored without affecting the system and making it difficult to maintain a steady operation of the system. In particular, in Operational Technology (OT) systems, which are often operated for longer periods of time than Information Technology (IT) systems, the equipment tends to be older with limited CPU processing power, and it is difficult to perform dynamic monitoring at the kernel level on a regular and steady basis due to the high processing overhead.

It is a main object of the present invention to provide a monitoring server apparatus, system, method, and program that can contribute to performing dynamic monitoring at a kernel level while ensuring steady and stable operation of a system.

### Solution to Problem

A monitoring server apparatus relating to a first aspect comprises an operation section configured to collect from monitored apparatuses predetermined logs excluding kernel trace information during operation, monitor an anomaly of the monitored apparatuses using a model created in advance, and perform dynamic monitoring by narrowing its focus to kernel space of a monitored apparatus having the anomaly when any anomaly has occurred.

A monitoring system relating to a second aspect comprises: monitored apparatuses; a management terminal; and the monitoring server apparatus relating to the first aspect.

A monitoring method relating to a third aspect is a monitoring method for monitoring an operation of a monitored apparatuses using hardware resources that comprises a step of collecting from monitored apparatuses predetermined logs excluding kernel trace information thereof during operation, monitoring an anomaly of the monitored apparatuses using a model created in advance, and performing dynamic monitoring by narrowing its focus to kernel space of a monitored apparatus having the anomaly when any anomaly has occurred.

A program relating to a fourth aspect causes hardware resources to execute a process of monitoring an operation of a monitored apparatuses and causes the hardware resources to execute a process of collecting from monitored apparatuses predetermined logs excluding kernel trace information thereof during operation, monitoring an anomaly of the monitored apparatuses using a model created in advance, and performing dynamic monitoring by narrowing its focus to kernel space of a monitored apparatus having the anomaly when any anomaly has occurred.

Further, the program(s) can be stored in a computer-readable storage medium. The storage medium may be a non-transitory one such as a semiconductor memory, a hard disk, a magnetic recording medium, an optical recording medium, and the like. Further, the present invention can also be realized as a computer program product. The program is supplied to a computer apparatus using an input device or from the outside via a communication interface, stored in a storage device, and operates a processor according to predetermined steps or processes. The program is capable of displaying the processing results thereof including an intermediate state, as necessary, via a display device step by step or is able to communicate with the outside via a communication interface. For instance, the computer apparatus for this purpose comprises a processor, a storage device, an input device, a communication interface, and a display device, if necessary, that can typically be connected to each other by a bus.

### Advantageous Effects of Invention

According to the first to the fourth aspects, it is possible to contribute to performing dynamic monitoring at a kernel level while ensuring steady and stable operation of a system.

### BRIEF DESCRIPTION OF DRAWINGS

FIG. 1 is a block diagram schematically illustrating a configuration of a monitoring system relating to Example Embodiment 1.

FIG. 2 is a block diagram schematically illustrating an example of a configuration of a monitored apparatus in the monitoring system relating to Example Embodiment 1.

FIG. 3 is a schematic illustration showing how kernel trace information is acquired in the monitoring system relating to Example Embodiment 1.

FIG. 4 is a schematic illustration showing an example of feature extraction from log(s) collected in model creation mode of a monitoring server apparatus in the monitoring system relating to Example Embodiment 1.

FIG. 5 is a schematic illustration showing an example of threshold setting in the model creation mode of the monitoring server apparatus in the monitoring system relating to Example Embodiment 1.

FIG. 6 is a schematic illustration showing an example of an anomaly in features extracted from log(s) collected in operation mode of the monitoring server apparatus in the monitoring system relating to Example Embodiment 1.

FIG. 7 is a flowchart schematically showing an operation of the monitoring server apparatus in the model creation mode in the monitoring system relating to Example Embodiment 1.

FIG. 8 is a flowchart schematically showing an operation of the monitoring server apparatus in the operation mode in the monitoring system relating to Example Embodiment 1.

FIG. 9 is a block diagram schematically illustrating an example of a configuration when the monitoring system relating to Example Embodiment 1 is applied to an OT system.

FIG. 10 is a sequence chart schematically showing an operation in the model creation mode when the monitoring system relating to Example Embodiment 1 is applied to an OT system.

FIG. 11 is a sequence chart schematically showing an operation in the operation mode when the monitoring system relating to Example Embodiment 1 is applied to an OT system.

FIG. 12 is a block diagram schematically illustrating a configuration of a monitoring server apparatus relating to Example Embodiment 2.

FIG. 13 is a block diagram schematically illustrating a configuration of hardware resources.

### EXAMPLE EMBODIMENTS

Example embodiments will be described with reference to the drawings. It should be noted that the drawing reference signs herein are given mainly to facilitate understanding and are not intended to limit the present invention to the illustrated modes. Further, the following example embodiments are merely examples and do not limit the present invention. Connection lines between blocks in the drawings referred to in the following description can be both bidirectional and unidirectional. A unidirectional arrow schematically shows a main flow of a signal (data) and does not exclude bidirectionality. Further, in a circuit diagram, block diagram, internal configuration diagram, and connection diagram shown in the disclosure of the present application, the input and output ends of each connection line have an input port and an output port, respectively, although not shown explicitly. The same applies to input/output interfaces. A program is executed by a computer apparatus, and the computer apparatus comprises, for instance, a processor, storage device, input device, communication interface, and a display device as necessary. The computer apparatus is configured to be able to perform wired or wireless communication with an internal device therein or with an external device (including a computer) via the communication interface.

### Example Embodiment 1

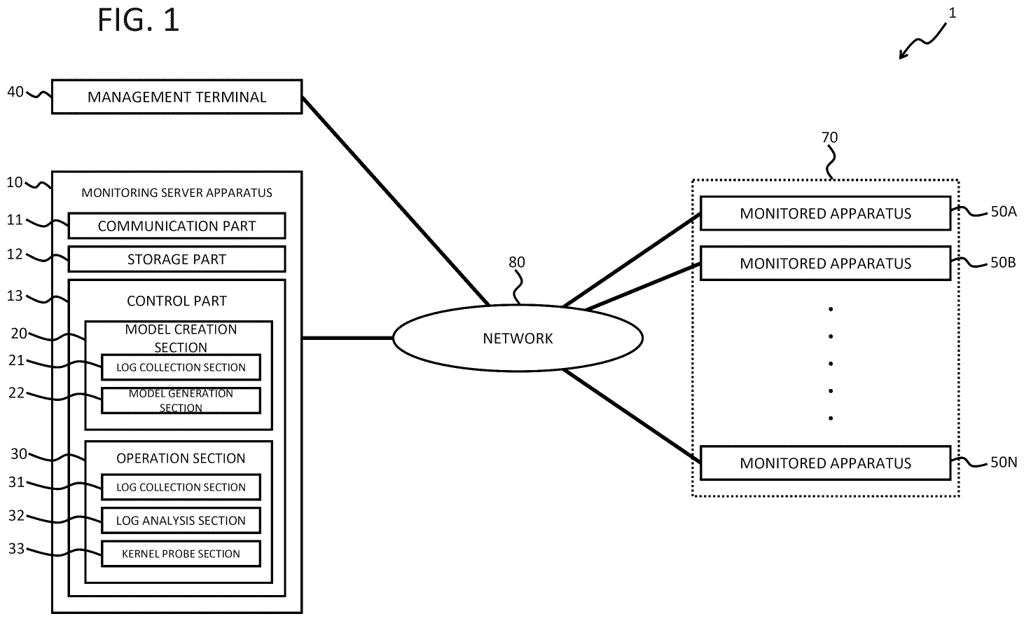

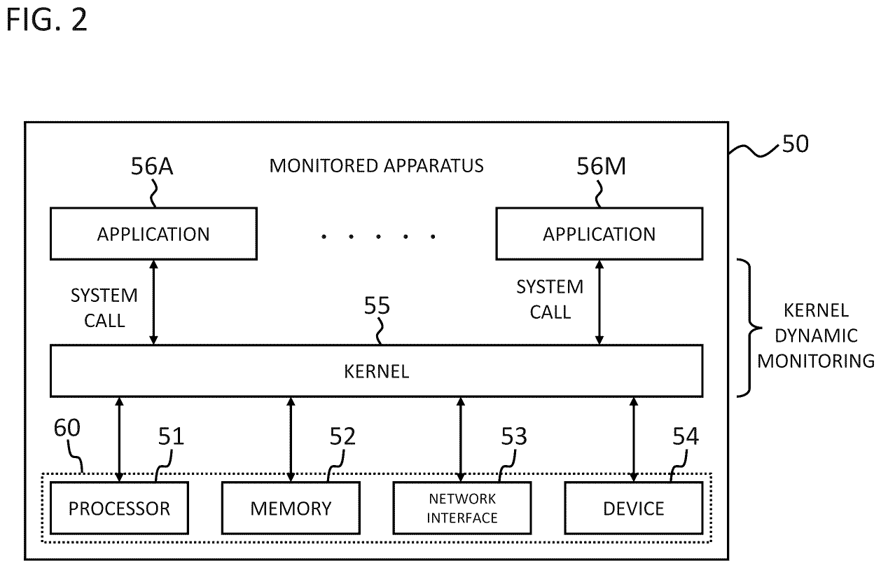

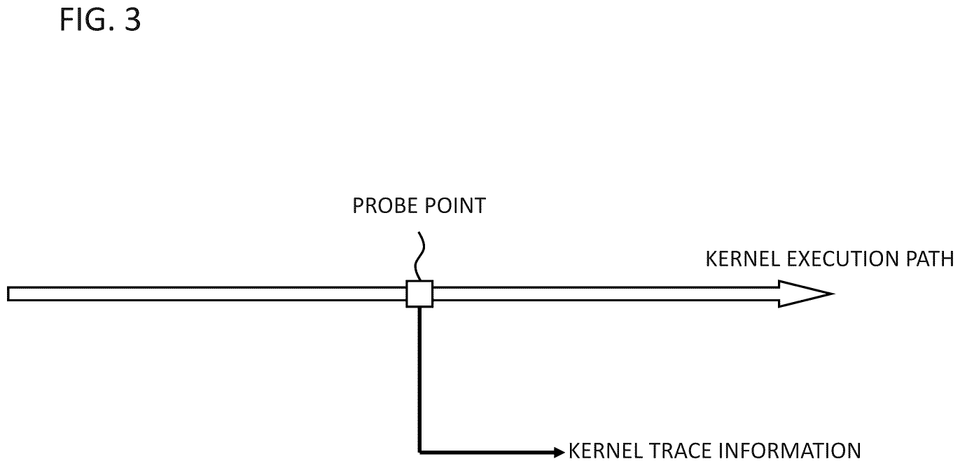

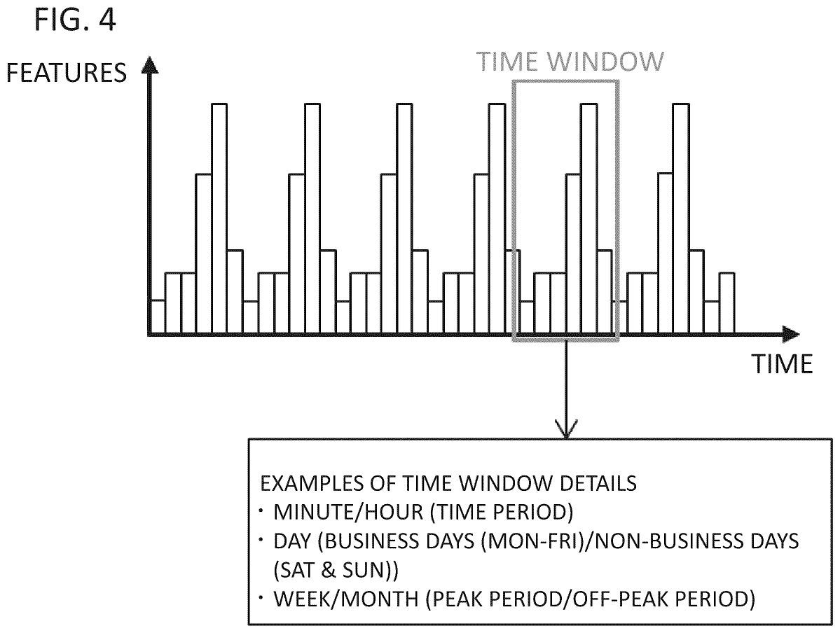

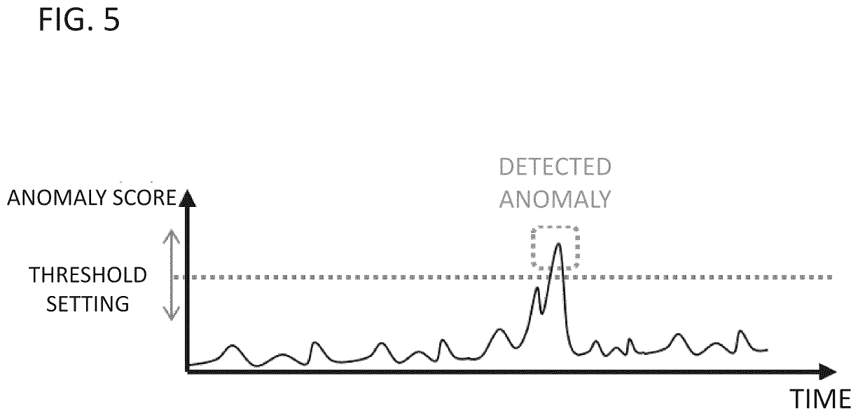

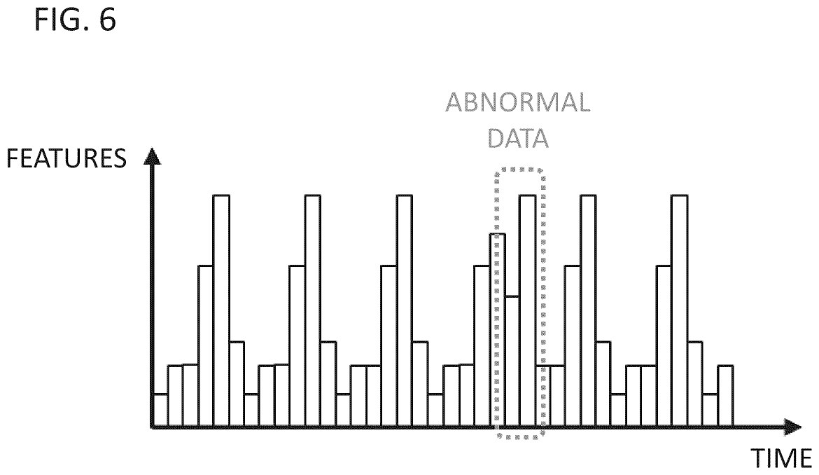

The following describes a monitoring system relating to Example Embodiment 1 with reference to the drawings. FIG. 1 is a block diagram schematically illustrating a configuration of the monitoring system relating to Example Embodiment 1. FIG. 2 is a block diagram schematically illustrating an example of a configuration of a monitored apparatus in the monitoring system relating to Example Embodiment 1. FIG. 3 is a schematic illustration showing how kernel trace information is acquired in the monitoring system relating to Example Embodiment 1. FIG. 4 is a schematic illustration showing an example of feature extraction from log(s) collected in model creation mode of a monitoring server apparatus in the monitoring system relating to Example Embodiment 1. FIG. 5 is a schematic illustration showing an example of threshold setting in the model creation mode of the monitoring server apparatus in the monitoring system relating to Example Embodiment 1. FIG. 6 is a schematic illustration showing an example of an anomaly in features extracted from log(s) collected in operation mode of the monitoring server apparatus in the monitoring system relating to Example Embodiment 1.

The monitoring system 1 is a system that monitors monitored apparatuses 50A to 50N (refer to FIG. 1). The monitoring system 1 can be applied to OT systems in factories, social infrastructure, and the like wherein routine operations and processes are repeated. The monitoring system 1 comprises the monitoring server apparatus 10, a management terminal 40, the monitored apparatuses 50A to 50N, and a network 80.

The monitoring server apparatus 10 is a server apparatus that determines the presence of an anomaly (anomalies) on the basis of predetermined log(s) collected from the monitored apparatuses 50A to 50N and monitors the behavior of the monitored apparatuses 50A to 50N in detail when any anomaly has occurred (refer to FIG. 1). As the monitoring server apparatus 10, for instance, a server apparatus comprising a computer that includes a processor, a memory, a network interface, etc., may be used. The monitoring server apparatus 10 is communicatively connected to the network 80. The monitoring server apparatus 10 has functionality of synchronizing with a system clock. The monitoring server apparatus 10 comprises a communication part 11, a storage part 12, and a control part 13.

The communication part 11 is a functional part that communicates information (wired or wireless communication) (refer to FIG. 1). The communication part 11 is communicatively connected to the network 80. The communication part 11 performs communication under control of the control part 13. The communication part 11 is able to transmit information to the management terminal 40 and the monitored apparatuses 50A to 50N. The communication part 11 is able to receive information from the management terminal 40 and the monitored apparatuses 50A to 50N.

The storage part 12 is a functional part that stores information (refer to FIG. 1). The storage part 12 writes and reads information under control of the control part 13. The storage part 12 stores program(s), tool(s), collected log(s), created model(s), and the like.

The control part 13 is a functional part that controls the communication part 11 and the storage part 12 (refer to FIG. 1). As the control part 13, for instance, a processor such as a CPU (Central Processing Unit), an MPU (Micro Processor Unit), and the like may be used. The control part 13 is able to perform predetermined information processing described in predetermined program(s) and tool(s) stored in the storage part 12 by executing the program(s) and tool(s). The control part 13 can be configured to virtually comprise a model creation section 20 and an operation section 30 by executing predetermined program(s) and tool(s) stored in the storage part 12.

The model creation section 20 is a functional section that collects various logs from the monitored apparatuses 50A to 50N before an operation to create a model used to determine whether the monitored apparatuses 50A to 50N are in a steady and stable state or experiencing an anomaly (anomalies) using a statistical analysis method(s) (refer to FIG. 1). The model creation section 20 is able to create a model by means of machine learning using various collected logs, and if necessary, an administrator can modify the model by using and operating the management terminal 40. As the model, a model with respect to invariants among the monitored apparatuses 50A to 50N may be used. The model creation section 20 comprises a log collection section 21 and a model generation section 22.

The log collection section 21 is a functional section that collects various logs from the monitored apparatuses 50A to 50N (refer to FIG. 1). Upon receiving a model creation command from the management terminal 40, the log collection section 21 starts the model creation mode and transmits log setting information to the monitored apparatuses 50A to 50N. Here, the log setting information may include, for instance, information for setting probe point(s) at predetermined location(s) of each kernel execution path of the monitored apparatuses 50A to 50N. The log collection section 21 collects various logs from the monitored apparatuses 50A to 50N that have received the log setting information. The various logs may include not only kernel trace information, but also data such as sensor information, performance (metrics) information, event information (event log such as data on internal processing, external interface(s), etc.) and the like of the monitored apparatuses 50A to 50N. Further, priorities, risk values based on asset-based analysis, and areas requiring intervention based on asset-based analysis may be set for the various collected logs in advance according to the transmission sources, which are the monitored apparatuses 50A to 50N. The log collection section 21 determines whether or not the number of the various collected logs is equal to or greater than a predetermined number. (The log collection section 21 may also determine whether or not a predetermined period of time has passed since the start of log collection.)

The model generation section 22 is a functional section that creates a model used to determine whether the monitored apparatuses 50A to 50N are in a steady and stable state or experiencing an anomaly (anomalies) using a statistical analysis method(s) on the basis of the various logs collected by the log collection section 21 (refer to FIG. 1). The model generation section 22 extracts features on the basis of the various logs collected by the log collection section 21. Here, the extracted features include, for instance, a specific log element such as an application log (for instance, syslog) and a system log, or a total number of logs by log level when the log is event information, and a specific log element such as polling (collected periodically) and clipping (thresholds) when the log is performance information.

The model generation section 22 performs correlation analysis (dimension reduction) to narrow down the extracted features to feature(s) (variable(s)) strongly correlated with kernel operation. Here, in an initial round of correlation analysis, the features are narrowed down to those most strongly correlated with kernel operation. If any issue arises during model verification, another around of correlation analysis can narrow the features down to those with the second strongest correlation with kernel operation after the features selected in the initial round. FIG. 4 shows an example of how selected features change over time. In FIG. 4, each time window represents one cycle, and a time window can be divided by a unit of minute/hour (time period), day (business days (Monday to Friday)/non-business days (Saturday and Sunday)) or week/month (peak period/off-peak period).

The model generation section 22 performs multivariate analysis (to calculate anomaly scores) using kernel trace information in the various collected logs as a target variable and log(s) related to the selected feature(s) as explanatory variable(s). Here, in the multivariate analysis, anomaly scores may be calculated using the k-nearest neighbors algorithm (refer to Math. 1 below). The model generation section 22 constructs a model that shows how anomaly scores calculated through the multivariate analysis change over time (see a portion excluding a set threshold in FIG. 5).

$$( k - nearest neighbors algorithm )$$

$$ln \frac{{π}_{0} {N}^{1} ( x )}{{π}_{1} {N}^{0} ( x )} \qquad [ Math . 1 ]$$

π0 is the proportion of normal data in the entire sample.
π1 is the proportion of abnormal data in the entire sample.
N0(x) is the proportion of normal data within the k nearest neighbors of x.
N1(x) is the proportion of abnormal data within the k nearest neighbors of x.
ln is the logarithm (log e) to natural logarithm base e.

The model generating section 22 sets a threshold for the anomaly scores in the constructed model (adjusting the threshold if the accuracy of the model is deemed insufficient). Here, the threshold is used to detect a sign(s) of system behavior that deviates from the model's steady and stable state. Further, the threshold can be set or changed so that the threshold line passes through a peak of a detected anomaly portion as shown in FIG. 5. If there is no peak corresponding to a detected anomaly portion in the constructed model, the threshold line is set at a position above a maximum peak of the model (at a position within a preset numerical range between the maximum peak value and the threshold).

The model generation section 22 verifies the model in which the threshold has been set or modified. Here, the model can be verified by, for instance, preparing a dataset containing both normal and abnormal data in advance, evaluating whether the number of samples correctly determined to be the normal or abnormal data is equal to or greater than a preset number, and evaluating whether the difference between the maximum peak value of the model and the threshold is within a preset numerical range. As a result of the verification, the model generation section 22 determines whether or not there is any issue (whether or not the number of correctly judged samples is equal to or greater than a preset number). If the verification result shows that there is no issue, the model generation section 22 determines whether or not the model is accurate (whether or not the difference between the maximum peak value of the model and the threshold is within a preset numerical range). If the model is determined to be accurate, the model generation section 22 transmits a creation completion notification to the management terminal 40 to notify that the model has been created.

The operation section 30 is a functional section that collects from the monitored apparatuses 50A to 50N predetermined log(s) excluding kernel trace information thereof during operation, monitors an anomaly (anomalies) of the monitored apparatuses 50A to 50N using the model created by the model creation section 20, and performs dynamic monitoring by narrowing its focus to kernel space of monitored apparatus(es) among 50A to 50N within a scope of impact of an anomaly when any anomaly has occurred (refer to FIG. 1). For the dynamic monitoring of kernel space, for instance, kernel tracing tools such as SystemTap (Kprobes), a loadable kernel module (LKM), perf (performance analysis tools for Linux (registered trademark)), ftrace, eBPF (Extended Berkeley Packet Filter), LKST (Linux (registered trademark) Kernel State Tracer), Vzet, etc., can be used. The dynamic monitoring of kernel space includes, for instance, monitoring access to kernel space (such as a system call) unintended by the system including malware, process tampering, and the like. The operation section 30 comprises a log collection section 31, a log analysis section 32, and a kernel probe section 33.

The log collection section 31 is a functional section that collects predetermined log(s) from the monitored apparatuses 50A to 50N (refer to FIG. 1). The predetermined log(s) exclude kernel trace information. Further, the predetermined log(s) may be log(s) that include features selected in the correlation analysis by the model generation section 22 due to their strong correlation with kernel operation.

The log analysis section 32 is a functional section that uses the model created by the model creation section 20 to analyze whether or not there is an anomaly (anomalies) in the collected predetermined log(s) (refer to FIG. 1). The log analysis section 32 extracts feature(s) from the collected predetermined log(s) to calculate anomaly score(s). The log analysis section 32 determines whether or not the anomaly score(s) (for instance, refer to the abnormal data in FIG. 6) are equal to or greater than the threshold set in the model created by the model creation section 20.

The kernel probe section 33 is a functional section that probes a kernel(s) of the source(s) of the predetermined log(s) determined to have an anomaly (anomalies) among the monitored apparatuses 50A to 50N (refer to FIG. 1). The kernel probe section 33 estimates a scope of impact of the abnormal condition(s) on the basis of the source(s) (any of the monitored apparatuses 50A to 50N) of the log(s) that contains features related to an anomaly score(s) equal to or greater than the threshold set in the model created by the model creation section 20. The scope of impact of the abnormal condition(s) can be estimated using, for instance, the various logs (including kernel trace information) collected by the log collection section 21 of the model creation section 20.

The kernel probe section 33 generates a probe script on the basis of the estimated scope of impact of the abnormal condition(s). In generating the probe script, probe points and timings for acquiring kernel trace information are narrowed down on the basis of the estimated scope of impact of the abnormal condition(s), and then the probe script is generated. For instance, rule(s) for recording monitored log(s) (kernel trace information) or rule(s) for extracting information from existing log format(s) are defined in advance. When an anomaly (anomalies) is detected, a specific log element(s) is extracted from the format of a log(s) under probe. In order to narrow down functions, system calls (probe points), processes, process backtraces, etc., under probe, the extracted log element(s) is reflected as a parameter(s), variable(s), etc., in a script template prepared for each probe target. Further, an LKM (loadable kernel module) of a kernel trace tool (such as SystemTap) can be utilized to generate a probe script, making it possible to add a kernel space tracing function without replacing the existing system. The kernel probe section 33 transmits the generated probe script to monitored apparatus(es) among 50A to 50N within the estimated scope of impact of the abnormal condition(s).

The kernel probe section 33 receives kernel trace information from the monitored apparatus(es) among 50A to 50N that have received the probe script. The kernel probe section 33 transmits the received kernel trace information to the management terminal 40. The kernel probe section 33 determines whether or not it has received a stop command from the management terminal 40. Upon receiving a stop command from the management terminal 40, the kernel probe section 33 transmits a stop command to the monitored apparatus(es) among 50A to 50N that have received the probe script.

The management terminal 40 is a terminal used by an administrator of the monitoring system 1 (refer to FIG. 1). The management terminal 40 is communicatively connected to the network 80 (wired or wireless communication). As the management terminal 40, for instance, a personal computer, a tablet terminal, a smartphone or the like may be used. The management terminal 40 is able to transmit a model creation command and operation start command to the monitoring server apparatus 10 through operation of an administrator. The management terminal 40 is able to receive and display a creation completion notification, kernel trace information, and apparatus stop notification from the monitoring server apparatus 10.

The monitored apparatuses 50A to 50N are various apparatuses to be monitored (refer to FIGS. 1 and 2). As the monitored apparatus(es) 50, for instance, a network device such as a switch, a router, etc., a security device such as a firewall, an IDS (Intrusion Detection System), an IPS (Intrusion Prevention System), etc., a SCADA (Supervisory Control And Data Acquisition) server, a PLC (Programmable Logic Controller), a control terminal, and the like may be used. The monitored apparatus(es) 50 are communicatively connected to the network 80 (wired or wireless communication). The monitored apparatus(es) 50 have functionality of synchronizing with a system clock. The monitored apparatus(es) 50 may comprise a processor 51, a memory 52, a network interface 53, and a variety of devices 54 (for instance, a sensor, a camera, a display device, an input device, an output device, etc.) as hardware 60. The monitored apparatus(es) 50 comprise a variety of applications 56A to 56M and a kernel 55 that handles processing and functions between the hardware 60 and the applications 56A to 56M. Note that the monitored apparatuses 50A to 50N may be collectively referred to as a monitored apparatus group 70.

When the monitored apparatuses 50A to 50N are in the model creation mode and receive the log setting information from the monitoring server apparatus 10, the monitored apparatuses 50A to 50N configure themselves to read various logs thereof and transmit the logs to the monitoring server apparatus 10 according to the log setting information. After the configuration, the monitored apparatuses 50A to 50N read various logs therefrom (including kernel trace information) and transmit the logs to the monitoring server apparatus 10.

In the operation mode, the monitored apparatuses 50A to 50N read predetermined logs (excluding kernel trace information) of the monitored apparatuses 50A to 50N themselves and transmit them to the monitoring server apparatus 10. Upon receiving a probe script from the monitoring server apparatus 10, the monitored apparatuses 50A to 50N set probe point(s) at predetermined location(s) in each kernel execution path of the monitored apparatuses 50A to 50N on the basis of the probe script and acquire kernel trace information from the probe point(s) to transmit the kernel trace information to the monitoring server apparatus 10. Upon receiving a stop command from the monitoring server apparatus 10, the monitored apparatuses 50A to 50N terminate the operations thereof.

The network 80 is a wired or wireless communication network that communicatively connects the monitoring server apparatus 10, the management terminal 40, and the monitored apparatuses 50 and 50A to 50N (refer to FIG. 1). The network 80 may be a LAN (Local Area Network), but may also be a different communication network such as a PAN (Personal Area Network), a MAN (Metropolitan Area Network), a WAN (Wide Area Network), a GAN (Global Area Network) and the like.

The following describes operations of the monitoring server apparatus in the monitoring system relating to Example Embodiment 1.

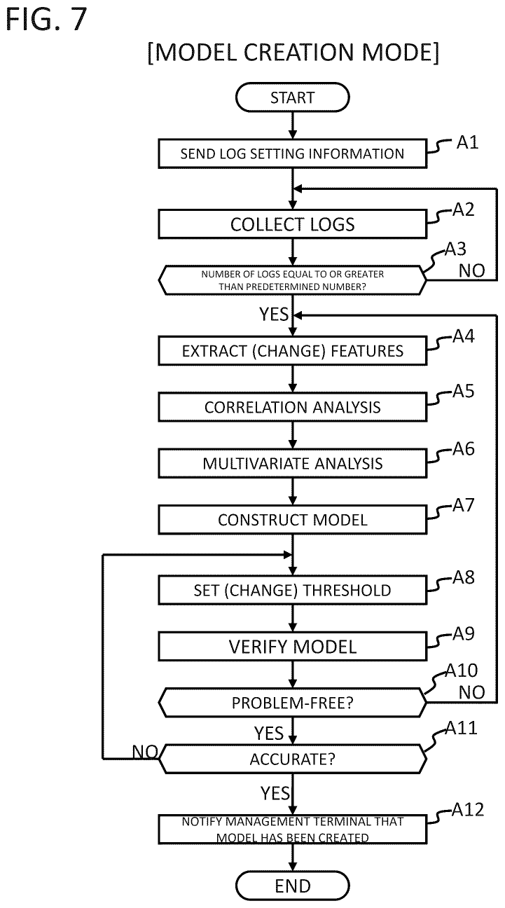

First, an operation of the monitoring server apparatus in the model creation mode will be described with reference to a drawing. FIG. 7 is a flowchart schematically showing an operation of the monitoring server apparatus in the model creation mode in the monitoring system relating to Example Embodiment 1. Refer to FIG. 1 for the configuration of the monitoring system.

First, upon receiving a model creation command from the management terminal 40, the log collection section 21 of the model creation section 20 of the control part 13 of the monitoring server apparatus 10 starts the model creation mode and transmits log setting information to the monitored apparatuses 50A to 50N (step A1). Here, the log setting information may include, for instance, information for setting probe point(s) at predetermined location(s) of each kernel execution path of the monitored apparatuses 50A to 50N. Further, upon receiving the log setting information, the monitored apparatuses 50A to 50N configure themselves to read various logs thereof and transmit the logs to the monitoring server apparatus 10 according to the log setting information, and after the configuration, the monitored apparatuses 50A to 50N are set to read various logs therefrom and transmit the logs to the monitoring server apparatus 10.

After the step A1 or when the number of logs is less than a predetermined number (“NO” in step A3), the log collection section 21 collects various logs from each of the monitored apparatuses 50A to 50N (step A2). The various logs may include not only kernel trace information, but also data such as sensor information, performance (metrics) information, event information (event log such as data on internal processing, external interface(s), etc.) and the like of the monitored apparatuses 50A to 50N.

Next, the log collection section 21 determines whether the number of the various collected logs is equal to or greater than a predetermined number (the step A3). (The log collection section 21 may also determine whether a predetermined period of time has passed since the start of log collection.) If the number of the various logs is less than a predetermined number (“NO” in the step A3), the operation returns to the step A2.

If the number of the logs is equal to or greater than a predetermined number (“YES” in the step A3) or if any issue arises during model verification (“NO” in step A10), the model generation section 22 of the model creation section 20 extracts features on the basis of the various collected logs (step A4).

Next, the model generation section 22 performs correlation analysis (dimension reduction) to narrow down the extracted features to feature(s) (variable(s)) strongly correlated with kernel operation (step A5).

Next, the model generation section 22 performs multivariate analysis (to calculate anomaly scores) using the kernel trace information in the various collected logs as a target variable and log(s) related to the selected feature(s) as explanatory variable(s) (step A6). In the multivariate analysis, anomaly scores may be calculated using the k-nearest neighbors algorithm.

Next, the model generation section 22 constructs a model (for instance, the portion excluding the set threshold in FIG. 5) that shows how anomaly scores calculated through the multivariate analysis change over time (step A7).

After the step A7 or if the accuracy of the model is deemed insufficient (“NO” in step A11), the model generating section 22 sets a threshold for the anomaly scores in the constructed model (adjusting the threshold if the accuracy of the model is deemed insufficient) (step A8).

Next, the model generation section 22 verifies the model in which the threshold has been set or changed (step A9). The model can be verified by, for instance, preparing a dataset containing both normal and abnormal data in advance, evaluating whether the number of samples correctly determined to be the normal or abnormal data is equal to or greater than a preset number, and evaluating whether the difference between a maximum peak value of the model and the threshold is within a preset numerical range.

Next, as a result of the verification, the model generation section 22 determines whether or not the verification is problem-free (whether or not the number of correctly judged samples is equal to or greater than a preset number) (the step A10). If the verification is not problem-free (“NO” in the step A10), the operation returns to the step A4.

If the verification is problem-free (“YES” in the step A10), the model generation section 22 determines whether or not the model is accurate (whether or not the difference between the maximum peak value of the model and the threshold is within a preset numerical range) as a result of the verification (the step A11). If the model is not accurate (“NO” in the step A11), the operation returns to the step A8.

If the model is accurate (“YES” in the step A11), the model generation section 22 transmits a creation completion notification to the management terminal 40 to notify that the model has been created (step A12), and then the operation terminates. Further, upon receiving the creation completion notification, the management terminal 40 displays it, allowing an administrator to confirm that the model has been created.

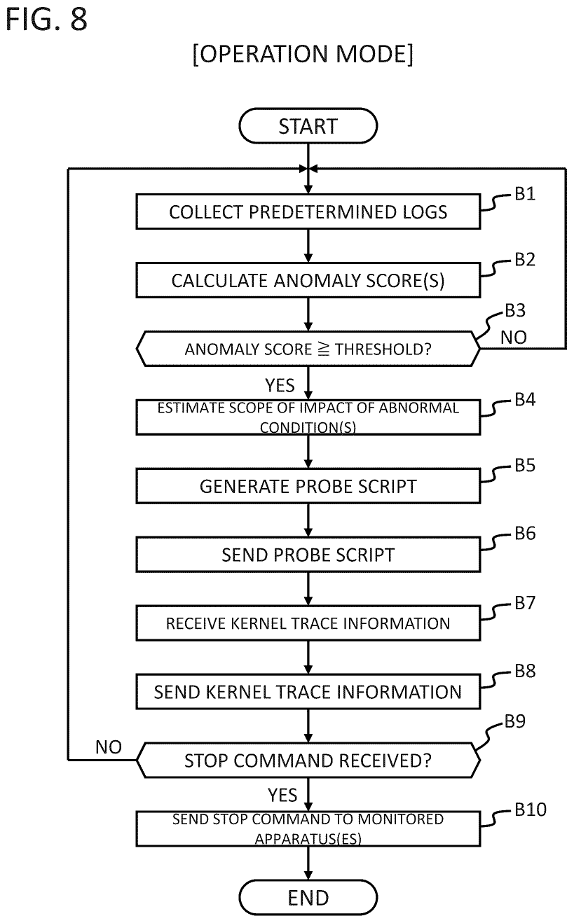

Next, an operation of the monitoring server apparatus in the operation mode will be described with reference to a drawing. FIG. 8 is a flowchart schematically showing an operation of the monitoring server apparatus in the operation mode in the monitoring system relating to Example Embodiment 1. Refer to FIG. 1 for the configuration of the monitoring system.

At the start, or when there is no anomaly (“NO” in step B3) or no stop command has been received (“NO” in step B9), the log collection section 31 of the operation section 30 of the control part 13 of the monitoring server apparatus 10 starts the operation mode and collects predetermined log(s) from the monitored apparatuses 50A to 50N upon receiving an operation start command from the management terminal 40 (step B1). Note that the predetermined log(s) collected here exclude kernel trace information. Further, the collected predetermined log(s) may be log(s) that include features selected in the correlation analysis in the step A5 due to their strong correlation with kernel operation.

Next, the log analysis section 32 of the operation section 30 extracts feature(s) from the collected predetermined log(s) to calculate anomaly score(s) using a predetermined mathematical formula(s) (for instance, the mathematical formula of the k-nearest neighbors algorithm) (step B2).

Next, the log analysis section 32 of the operation section 30 determines whether or not calculated anomaly score(s) are equal to or greater than the threshold in the model (created by the model creation section 20) (the step B3). If there is no anomaly (“NO” in the step B3), the operation returns to the step B1.

If any anomaly is found (“YES” in the step B3), the kernel probe section 33 of the operation section 30 estimates a scope of impact of the abnormal condition(s) on the basis of the source(s) (any of the monitored apparatuses 50A to 50N) of the log(s) that contains features related to the anomaly score(s) (step B4). Note that the scope of impact of the abnormal condition(s) can be estimated using, for instance, the various logs (including the kernel trace information) collected in the step A2.

Next, the kernel probe section 33 generates a probe script on the basis of the estimated scope of impact of the abnormal condition(s) (step B5).

Next, the kernel probe section 33 transmits the generated probe script to corresponding monitored apparatus(es) among 50A to 50N within the estimated scope of impact of the abnormal condition(s) (step B6).

Note that, when receiving the probe script, the corresponding monitored apparatus(es) among 50A to 50N set probe point(s) at predetermined location(s) in each kernel execution path of the monitored apparatuses 50A to 50N on the basis of the probe script and acquire kernel trace information from the probe point(s) to transmit the kernel trace information to the monitoring server apparatus 10. While the probe point(s) are being set, no changes are made to existing operation program(s).

Next, the kernel probe section 33 receives the kernel trace information from the monitored apparatus(es) among 50A to 50N that have received the probe script (step B7).

Next, the kernel probe section 33 transmits the received kernel trace information to the management terminal 40 (step B8). Note that, upon receiving kernel trace information, the management terminal 40 displays this kernel trace information, allowing an administrator to check whether or not there is any kernel anomaly. If the administrator determines that there is a kernel anomaly (kernel anomalies), he or she will operate the management terminal 40 to transmit a stop command to the monitoring server apparatus 10.

Next, the kernel probe section 33 determines whether or not it has received a stop command (the step B9). If no stop command has been received (“NO” in the step B9), the operation returns to the step B1.

If a stop command has been received (“YES” in the step B9), the kernel probe section 33 transmits a stop command to the monitored apparatus(es) among 50A to 50N that have received the probe script (step B10), and then the operation terminates. Further, upon receiving the stop command, the corresponding monitored apparatus(es) among 50A to 50N stop operating.

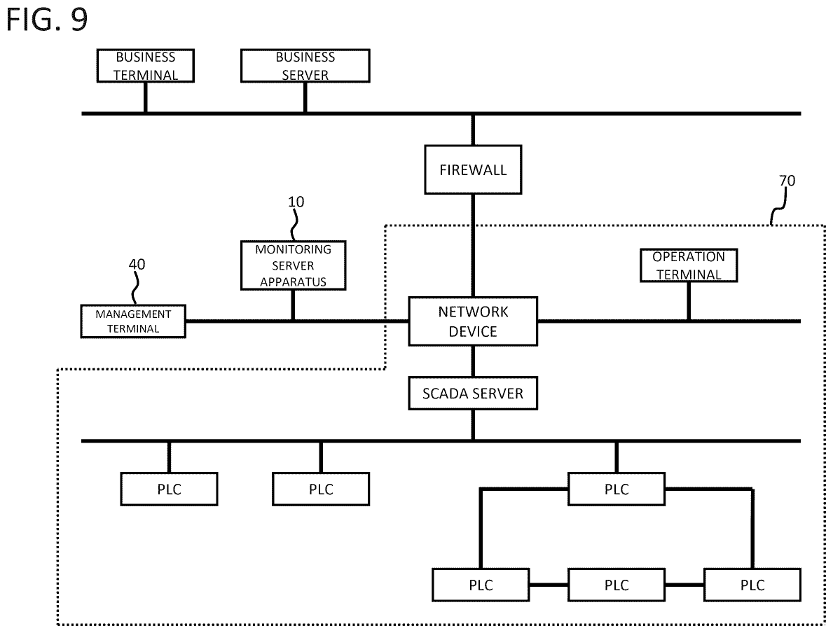

The monitoring system described above can be applied to an OT system shown in FIG. 9. In FIG. 9, the monitored apparatus group 70 include a network device, an operation terminal, a SCADA (Supervisory Control And Data Acquisition) server, and a plurality of PLCs (Programmable Logic Controllers).

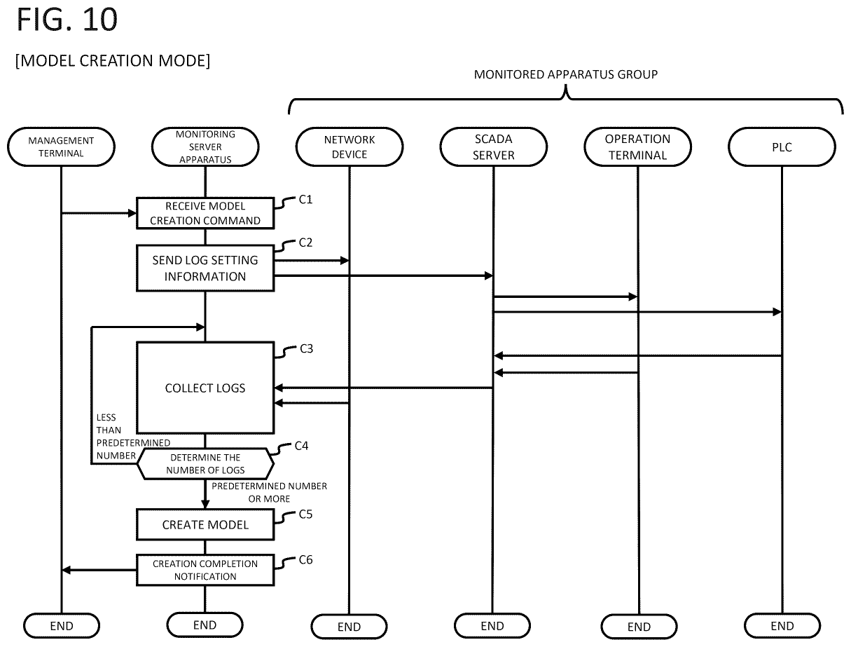

In the OT system shown in FIG. 9, upon receiving a model creation command from the management terminal 40 (step C1 in FIG. 10), the monitoring server apparatus 10 starts the model creation mode and transmits log setting information to the network device and the SCADA server (step C2 in FIG. 10). Upon receiving the log setting information, the SCADA server transmits this log setting information to the operation terminal and the PLCs. As a result, the operation terminal and the PLCs transmit logs to the monitoring server apparatus 10 via the SCADA server, and the SCADA server and the network device also transmit logs to the monitoring server apparatus 10. The monitoring server apparatus 10 collects the logs from the network device, the SCADA server, the operation terminal, and the PLCs (step C3 in FIG. 10) and determines whether or not the number of the collected logs is equal to or greater than a preset number (step C4 in FIG. 10). If the number of the logs is less than a preset number, the monitoring server apparatus 10 collects logs as in the step C3. If the number of the logs is equal to or greater than a preset number, the monitoring server apparatus 10 creates a model (step C5), transmits a creation completion notification to the management terminal 40 once the model has been created (step C6), and then terminates the model creation mode.

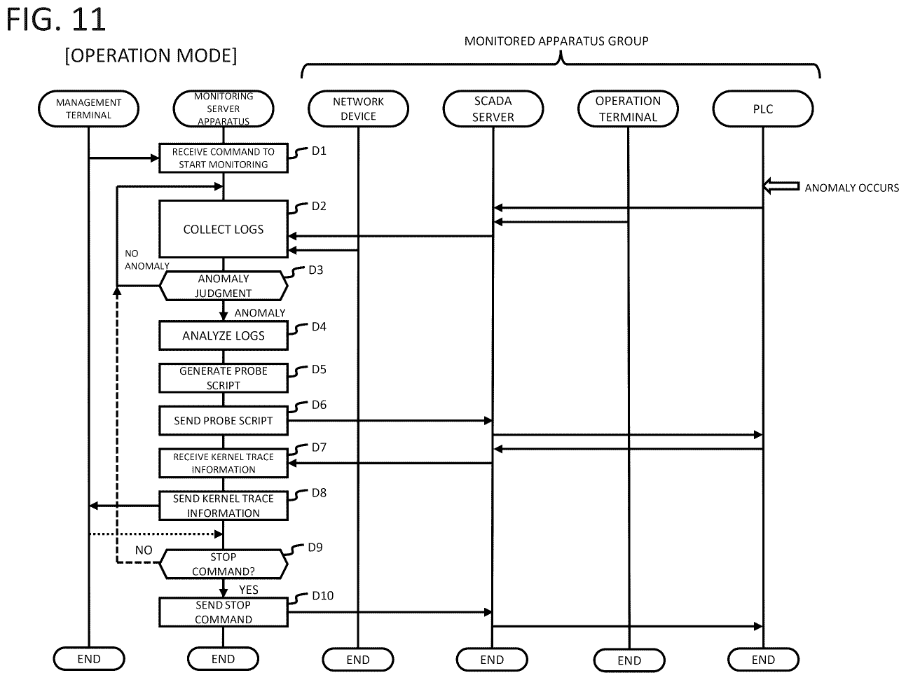

When the monitoring server apparatus 10 receives an operation start command from the management terminal 40 (step D1 in FIG. 11) after the model creation mode has terminated, the monitoring server apparatus 10 collects logs (excluding kernel trace information) from the network device, the SCADA server, the operation terminal, and the PLCs (step D2 in FIG. 11). The operation terminal and the PLCs transmit the logs therefrom to the monitoring server apparatus 10 via the SCADA server, and the SCADA server and the network device transmit the logs therefrom to the monitoring server apparatus 10. The monitoring server apparatus 10 analyzes the collected logs (step D3 in FIG. 11) to determine whether or not there is any anomaly (step D4 in FIG. 11). If no anomaly is found, the monitoring server apparatus 10 returns to the step D2, and if there is any anomaly, it generates a probe script (step D5 in FIG. 11). If the anomaly (anomalies) is suspected to have occurred in a PLC(s), the monitoring server apparatus 10 transmits the generated probe script to the PLC(s) via the SCADA server (step D6 in FIG. 11). Upon receiving the probe script, the PLC(s) transmits kernel trace information to the monitoring server apparatus 10 on the basis of the probe script, and the monitoring server apparatus 10 receives the kernel trace information from the PLC(s) (step D7 in FIG. 11) and transmits this kernel trace information to the management terminal 40 (step D8 in FIG. 11). By receiving and displaying the kernel trace information on the management terminal 40, an administrator determines whether or not any anomaly has occurred. If an anomaly (anomalies) has occurred, he or she transmits a stop command from the management terminal 40, and if no anomaly is found, he or she does not do anything. The monitoring server apparatus 10 determines whether or not there is a stop command from the management terminal 40 (step D9 in FIG. 11). If there is a stop command, the monitoring server apparatus 10 transmits the stop command to the PLC(s) via the SCADA server (step D10 in FIG. 11), and if there is no stop command, it returns to the step D2.

According to Example Embodiment 1, logs (excluding kernel trace information) from the monitored apparatuses 50A to 50N are collected during operation to monitor an anomaly (anomalies), and when an anomaly (anomalies) occurs, kernel trace information of monitored apparatuses among 50A to 50N having an anomaly (anomalies) can be acquired and referred to; therefore, it is possible to contribute to performing dynamic monitoring at a kernel level while ensuring steady and stable operation of a system. In other words, by performing dynamic monitoring that narrows down kernel probe points and timings to be traced when an anomaly (anomalies) occurs, it becomes possible to reduce the CPU processing load and ensure the system's steady and stable operation while taking security measures to address failure close to the kernel or hardware, cyberattack, system tampering, etc., and investigating the causes thereof.

### Example Embodiment 2

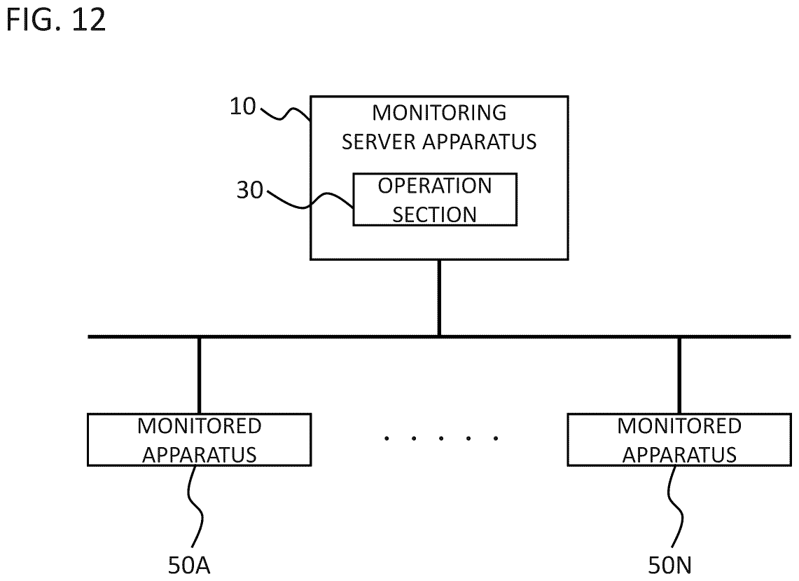

The following describes a monitoring server apparatus relating to Example Embodiment 2 with reference to a drawing. FIG. 12 is a block diagram schematically illustrating a configuration of the monitoring server apparatus relating to Example Embodiment 2.

The monitoring server apparatus 10 is an apparatus that monitors monitored apparatuses 50A to 50N. The monitoring server apparatus 10 comprises an operation section 30 that monitors the monitored apparatuses 50A to 50N during operation. The operation section 30 collects from the monitored apparatuses 50A to 50N predetermined logs excluding kernel trace information thereof. The operation section 30 monitors an anomaly (anomalies) of the monitored apparatuses 50A to 50N using a model created in advance. The operation section 30 performs dynamic monitoring by narrowing its focus to kernel space of monitored apparatuses among 50A to 50N having an anomaly (anomalies) when any anomaly has occurred.

According to Example Embodiment 2, by collecting logs (excluding kernel trace information) from the monitored apparatuses 50A to 50N during operation to monitor an anomaly (anomalies) and acquiring kernel trace information of monitored apparatuses among 50A to 50N having an anomaly (anomalies) when any anomaly has occurred, it is possible to contribute to performing dynamic monitoring at a kernel level while ensuring steady and stable operation of a system.

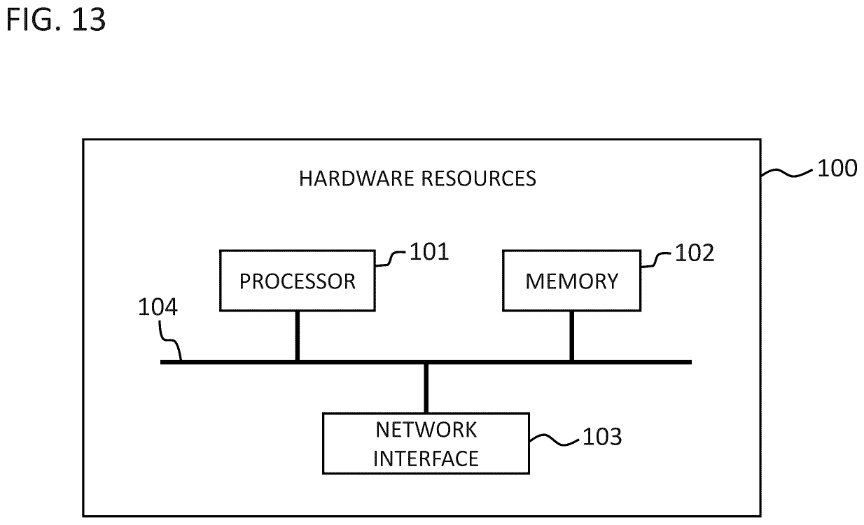

Further, the monitoring server apparatus and the management terminal relating to Example Embodiments 1 and 2 can be configured by so-called hardware resources (information processing apparatus, computer) and may employ a configuration illustrated in FIG. 13. For instance, hardware resources 100 comprise a processor 101, a memory 102, and a network interface 103, which are connected to each other by an internal bus 104.

Note that the configuration shown in FIG. 13 is not intended to limit the hardware configuration of the hardware resources 100. The hardware resources 100 may include hardware not shown in the drawing (for instance, an input/output interface). In addition, the number of units such as the processor 101 included in the apparatus is not limited to the example shown in FIG. 13; for instance, a plurality of the processors 101 may be included in the hardware resources 100. As the processor 101, for instance, a CPU (Central Processing Unit), an MPU (Micro Processor Unit), a GPU (Graphics Processing Unit), and the like may be used.

As the memory 102, for instance, a RAM (Random Access Memory), a ROM (Read-Only Memory), an HDD (Hard Disk Drive), an SSD (Solid State Drive), and the like may be used.

As the network interface 103, for instance, a LAN (Local Area Network) card, a network adaptor, a network interface card, and the like may be used.

The functions of the hardware resources 100 are achieved by the processing modules described above. These processing modules are realized by, for instance, having the processor 101 execute a program stored in the memory 102. Further, the program can be downloaded via a network or can be updated using a storage medium storing the program. In addition, the processing modules may be realized by a semiconductor chip. In other words, the functions performed by the processing modules may be realized by running software on some kind of hardware.

Some or all of the example embodiments above can be described as (but not limited to) the following Supplementary Notes.

### [Supplementary Note 1]

A monitoring server apparatus, comprising an operation section configured to collect from monitored apparatus(es) predetermined log(s) excluding kernel trace information thereof during operation, monitor an anomaly (anomalies) of the monitored apparatus(es) using a model created in advance, and perform dynamic monitoring by narrowing its focus to kernel space of the monitored apparatus(es) having an anomaly (anomalies) when any anomaly has occurred.

### [Supplementary Note 2]

The monitoring server apparatus according to Supplementary Note 1, wherein
the operation section comprises:
a log collection section configured to collect from the monitored apparatus(es) the predetermined log(s) excluding the kernel trace information thereof;
a log analysis section configured to use the model to analyze whether or not there is an anomaly (anomalies) in the predetermined log(s); and
a kernel probe section configured to probe a kernel(s) of the source(s) of the predetermined log(s) having an anomaly (anomalies) among the monitored apparatuses when any of the predetermined log(s) is determined to have an anomaly (anomalies).

### [Supplementary Note 3]

The monitoring server apparatus according to Supplementary Note 2, wherein
the log analysis section is configured to extract feature(s) from the predetermined log(s) to calculate an anomaly score(s) using a predetermined mathematical formula(s), and determine whether or not the anomaly score(s) is equal to or greater than a threshold set in the model.

### [Supplementary Note 4]

The monitoring server apparatus according to Supplementary Note 3, wherein
the kernel probe section is configured to estimate a scope of impact of an abnormal condition(s) on the basis of a source(s) of the predetermined log(s) that contains the feature(s) related to the anomaly score(s) equal to or greater than the threshold, generate a probe script on the basis of the scope of impact of the abnormal condition(s), transmit the probe script to the monitored apparatus(es) within the scope of impact of the abnormal condition(s), and receive kernel trace information from the monitored apparatus(es) that have received the probe script.

### [Supplementary Note 5]

The monitoring server apparatus according to Supplementary Note 4, wherein
the kernel probe section is further configured to transmit the kernel trace information to a management terminal, determine whether or not the kernel probe section has received a stop command from the management terminal, and upon receiving the stop command, transmit a stop command to the monitored apparatus(es) that have received the probe script.

### [Supplementary Note 6]

The monitoring server apparatus according to any one of Supplementary Notes 1 to 5, further comprising:
a model creation section configured to collect various logs including kernel trace information of the monitored apparatus(es) before an operation to create a model used to determine whether the monitored apparatus(es) are in a steady and stable state or experiencing an anomaly (anomalies) using a statistical analysis method(s), wherein
the model created in advance is a model created by the model creation section.

### [Supplementary Note 7]

The monitoring server apparatus according to Supplementary Note 6, wherein
the model creation section comprises:
a log collection section configured to collect the various logs including the kernel trace information from the monitored apparatus(es); and a model generation section configured to generate the model using a statistical analysis method(s) on the basis of the various logs.

### [Supplementary Note 8]

The monitoring server apparatus according to Supplementary Note 7, wherein
the log collection section is configured to transmit log setting information to the monitored apparatus(es), collect the various logs including the kernel trace information from the monitored apparatus(es) that have received the log setting information, and determine whether or not the number of the various logs is equal to or greater than a predetermined number or whether or not a predetermined period of time has passed since a start of log collection.

### [Supplementary Note 9]

The monitoring server apparatus according to Supplementary Note 7 or 8, wherein
the model generation section is configured to extract features on the basis of the various logs, perform correlation analysis to narrow down the features to feature(s) strongly correlated with kernel operation, perform multivariate analysis to calculate anomaly scores using kernel trace information in the various logs as a target variable and log(s) related to the selected feature(s) as explanatory variable(s), construct a model that shows how the anomaly scores change over time, and set a threshold for the anomaly scores in the model.

### [Supplementary Note 10]

The monitoring server apparatus according to Supplementary Note 9, wherein
the model generation section is further configured to verify the model in which the threshold has been set by preparing a dataset containing both normal and abnormal data in advance, evaluating whether the number of samples correctly determined to be the normal data or the abnormal data is equal to or greater than a preset number, and evaluating whether the difference between a maximum peak value of the model and the threshold is within a preset numerical range.

### [Supplementary Note 11]

A monitoring system, comprising:
a monitored apparatus(es);
a management terminal; and
the monitoring server apparatus according to any one of Supplementary Notes 1 to 10.

### [Supplementary Note 12]

A monitoring method for monitoring an operation(s) of a monitored apparatus(es) using hardware resources, the monitoring method comprising:
a step of collecting from monitored apparatus(es) predetermined log(s) excluding kernel trace information thereof during operation, monitoring an anomaly (anomalies) of the monitored apparatus(es) using a model created in advance, and performing dynamic monitoring by narrowing its focus to kernel space of the monitored apparatus(es) having an anomaly (anomalies) when any anomaly has occurred.

### [Supplementary Note 13]

A program causing hardware resource to execute a process of monitoring an operation(s) of a monitored apparatus(es), the program causing the hardware resources to execute:
a process of collecting from monitored apparatus(es) predetermined log(s) excluding kernel trace information thereof during operation, monitoring an anomaly (anomalies) of the monitored apparatus(es) using a model created in advance, and performing dynamic monitoring by narrowing its focus to kernel space of the monitored apparatus(es) having an anomaly (anomalies) when any anomaly has occurred.

Further, the disclosure of each Patent Literature cited above is incorporated herein in its entirety by reference thereto and can be used as a basis or a part of the present invention as needed. It is to be noted that it is possible to modify or adjust the example embodiments or examples within the scope of the whole disclosure of the present invention (including the Claims and the figures) and based on the basic technical concept thereof. Further, it is possible to variously combine or select (or deselect if necessary) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the figures, and the technical concept of the present invention. Further, any numerical values or ranges disclosed herein should be interpreted that any intermediate or lower values or subranges falling within the disclosed ranges are also disclosed even without explicit recital thereof. In addition, using some or all of the disclosed elements in each literature cited above as necessary in combination with the elements described herein as part of the disclosure of the present invention in accordance with the object of the present invention shall be considered to be included in (or belong to) the disclosed elements of the present application.

### REFERENCE SIGNS LIST

1: monitoring system
10: monitoring server apparatus
11: communication part
12: storage part
13: control part
20: model creation section
21: log collection section
22: model generation section
30: operation section
31: log collection section
32: log analysis section
33: kernel probe section
40: management terminal
50, 50A to 50N: monitored apparatus
51: processor
52: memory
53: network interface
54: device
55: kernel
56A to 56M: application
60: hardware
70: monitored apparatus group
80: network
100: hardware resources
101: processor
102: memory
103: network interface
104: internal bus

What is claimed is:

1. A monitoring server apparatus, comprising an operation section configured to collect from monitored apparatuses predetermined logs excluding kernel trace information during operation, monitor an anomaly of the monitored apparatuses using a model created in advance, and perform dynamic monitoring by narrowing its focus to kernel space of a monitored apparatus having the anomaly when any anomaly has occurred.

2. The monitoring server apparatus according to claim 1, wherein
the operation section comprises:
a log collection section configured to collect from the monitored apparatuses the predetermined logs excluding the kernel trace information;
a log analysis section configured to use the model to analyze whether or not there is an anomaly in the predetermined logs; and
a kernel probe section configured to probe a kernel of a source of the predetermined logs having an anomaly among the monitored apparatuses when any of the predetermined logs is determined to have an anomaly.

3. The monitoring server apparatus according to claim 2, wherein
the log analysis section is configured to extract feature from the predetermined logs to calculate an anomaly score using a predetermined mathematical formula, and determine whether or not the anomaly score is equal to or greater than a threshold set in the model.

4. The monitoring server apparatus according to claim 3, wherein
the kernel probe section is configured to estimate a scope of impact of an abnormal condition on the basis of a source of the predetermined logs that contains the feature related to the anomaly score equal to or greater than the threshold, generate a probe script on the basis of the scope of impact of the abnormal condition, transmit the probe script to the monitored apparatuses within the scope of impact of the abnormal condition, and receive kernel trace information from the monitored apparatuses that have received the probe script.

5. The monitoring server apparatus according to claim 4, wherein
the kernel probe section is further configured to transmit the kernel trace information to a management terminal, determine whether or not the kernel probe section has received a stop command from the management terminal, and upon receiving the stop command, transmit a stop command to the monitored apparatuses that have received the probe script.

6. The monitoring server apparatus according to claim 1, further comprising:
a model creation section configured to collect various logs including kernel trace information of the monitored apparatuses before an operation to create a model used to determine whether the monitored apparatuses are in a steady and stable state or experiencing an anomaly using a statistical analysis method, wherein
the model created in advance is a model created by the model creation section.

7. The monitoring server apparatus according to claim 6, wherein
the model creation section comprises:
a log collection section configured to collect the various logs including the kernel trace information from the monitored apparatuses; and
a model generation section configured to generate the model using a statistical analysis method on the basis of the various logs.

8. The monitoring server apparatus according to claim 7, wherein
the log collection section is configured to transmit log setting information to the monitored apparatuses, collect the various logs including the kernel trace information from the monitored apparatuses that have received the log setting information, and determine whether or not the number of the various logs is equal to or greater than a predetermined number or whether or not a predetermined period of time has passed since a start of log collection.

9. The monitoring server apparatus according to claim 7, wherein
the model generation section is configured to extract features on the basis of the various logs, perform correlation analysis to narrow down the features to feature strongly correlated with kernel operation, perform multivariate analysis to calculate anomaly scores using kernel trace information in the various logs as a target variable and logs related to the selected feature as explanatory variable, construct a model that shows how the anomaly scores change over time, and set a threshold for the anomaly scores in the model.

10. The monitoring server apparatus according to claim 9, wherein
the model generation section is further configured to verify the model in which the threshold has been set by preparing a dataset containing both normal and abnormal data in advance, evaluating whether the number of samples correctly determined to be the normal data or the abnormal data is equal to or greater than a preset number, and evaluating whether a difference between a maximum peak value of the model and the threshold is within a preset numerical range.

11. A monitoring system, comprising:
monitored apparatuses;
a management terminal; and
the monitoring server apparatus according to claim 1.

12. A monitoring method for monitoring an operation of a monitored apparatuses using hardware resources, the monitoring method comprising:
collecting from monitored apparatuses predetermined logs excluding kernel trace information during operation, monitoring an anomaly of the monitored apparatuses using a model created in advance, and performing dynamic monitoring by narrowing its focus to kernel space of a monitored apparatus having the anomaly when any anomaly has occurred.

13. A non-transitory computer readable medium storing a program causing hardware resource to execute a process of monitoring an operation of a monitored apparatuses, the program causing the hardware resources to execute:
a process of collecting from monitored apparatuses predetermined logs excluding kernel trace information during operation, monitoring an anomaly of the monitored apparatuses using a model created in advance, and performing dynamic monitoring by narrowing its focus to kernel space of a monitored apparatus having the anomaly when any anomaly has occurred.

14. The monitoring method for monitoring an operation of the monitored apparatuses using hardware resources according to claim 12, the monitoring method further comprising:
log collecting to collect from the monitored apparatuses the predetermined logs excluding the kernel trace information;
analyzing to use the model to analyze whether or not there is an anomaly in the predetermined logs; and
kernel probing to probe a kernel of a source of the predetermined logs having an anomaly among the monitored apparatuses when any of the predetermined logs is determined to have an anomaly.

15. The monitoring method for monitoring an operation of the monitored apparatuses using hardware resources according to claim 14, wherein
log analyzing is configured to extract feature from the predetermined logs to calculate an anomaly score using a predetermined mathematical formula, and determine whether or not the anomaly score is equal to or greater than a threshold set in the model.

16. The monitoring method for monitoring an operation of the monitored apparatuses using hardware resources according to claim 15, wherein
kernel probing is configured to estimate a scope of impact of an abnormal condition on the basis of a source of the predetermined logs that contains the feature related to the anomaly score equal to or greater than the threshold, generate a probe script on the basis of the scope of impact of the abnormal condition, transmit the probe script to the monitored apparatuses within the scope of impact of the abnormal condition, and receive kernel trace information from the monitored apparatuses that have received the probe script.

17. The monitoring method for monitoring an operation of the monitored apparatuses using hardware resources according to claim 16, wherein
kernel probing is further configured to transmit the kernel trace information to a management terminal, determine whether or not the kernel probe section has received a stop command from the management terminal, and upon receiving the stop command, transmit a stop command to the monitored apparatuses that have received the probe script.

18. The monitoring method for monitoring an operation of the monitored apparatuses using hardware resources according to claim 12, further comprising:
model creating to collect various logs including kernel trace information of the monitored apparatuses before an operation to create a model used to determine whether the monitored apparatuses are in a steady and stable state or experiencing an anomaly using a statistical analysis method, wherein
the model created in advance is a model created by the model creation section.

19. The monitoring method for monitoring an operation of the monitored apparatuses using hardware resources according to claim 18, wherein
model creating comprises:
log collecting to collect the various logs including the kernel trace information from the monitored apparatuses; and
model generating to generate the model using a statistical analysis method on the basis of the various logs.

20. The monitoring method for monitoring an operation of the monitored apparatuses using hardware resources according to claim 19, wherein
log collecting is configured to transmit log setting information to the monitored apparatuses, collect the various logs including the kernel trace information from the monitored apparatuses that have received the log setting information, and determine whether or not the number of the various logs is equal to or greater than a predetermined number or whether or not a predetermined period of time has passed since a start of log collection.

21. The monitoring method for monitoring an operation of the monitored apparatuses using hardware resources according to claim 19, wherein
model generating is configured to extract features on the basis of the various logs, perform correlation analysis to narrow down the features to feature strongly correlated with kernel operation, perform multivariate analysis to calculate anomaly scores using kernel trace information in the various logs as a target variable and logs related to the selected feature as explanatory variable, construct a model that shows how the anomaly scores change over time, and set a threshold for the anomaly scores in the model.

22. The monitoring method for monitoring an operation of the monitored apparatuses using hardware resources according to claim 21, wherein
model generating is further configured to verify the model in which the threshold has been set by preparing a dataset containing both normal and abnormal data in advance, evaluating whether the number of samples correctly determined to be the normal data or the abnormal data is equal to or greater than a preset number, and evaluating whether a difference between a maximum peak value of the model and the threshold is within a preset numerical range.
